(19) United States
(12) Patent Application Publication
(10) Pub. No.: US 2011/0113636 A1
(43) Pub. Date: May 19, 2011

(54) BLADE FOR PAPER PUNCHES

(76) Inventor: Chien Chuan HUANG, Chang Hua City (TW)

(21) Appl. No.: 12/618,980

(22) Filed: Nov. 16, 2009

(51) Int. Cl. B26B 9/02; B26D 5/10

(52) U.S. Cl. 30/357; 83/618

(57) ABSTRACT

A blade for paper punches includes a hollow tubular body with a passage defined axially therethrough and an inclined edge is defined in a lower end of the body. An angle between the inclined edge and a stack of paper sheet is in a range between 15 to 50 degrees. A spring is located in the passage of the body so as to bias a push rod which is movable in the passage to remove debris from the passage.

### FIELD OF THE INVENTION

The present invention relates to a blade, and more particularly, to a blade of a paper punch and the blade is efficient for punching paper sheets with less force.

### BACKGROUND OF THE INVENTION

A conventional blade 4 of a paper punch is shown in FIGS. 10 and 11, and generally includes a solid cylindrical body which is movably inserted through a frame 5 on the paper punch and a lower end of the blade 4 includes an inverted V-shaped recess so as to form two tips 41 and two side edges 42 when view from side as shown in FIG. 10. A curved surface 43 is defined in an inner end of the inverted V-shaped recess so as to accommodate the debris “b” of the paper sheets “a” after being punched. A vertical height from the tips 41 to the inner top of the curved surface 43 is designated as “h”. Referring to FIG. 12 which shows the relationship between the force required to punch the paper sheets, wherein the X-axis represents the number of the paper sheets and the Y-axis represents the force required. 20.6 kg of force is required to punch through 10 sheets of paper sheets, 48.4 kg of force is required to punch through 20 sheets of paper of sheets, 63.0 kg of force is required to punch through 30 sheets of paper sheets, 95.0 kg of force is required to punch through 40 sheets of paper sheets, and 120.0 kg of force is required to punch through 50 sheets of paper sheets.

When punching, the two tips 41 of the blade 4 are simultaneously contact the top sheet of the paper sheets so that there are two resistance points coming from the paper sheets to the blade 4 and the resistance force at the initial stage of punching will be significant so that the user has to apply a larger force to penetrate the paper sheets. During the punching, the paper debris “b” enters into the inverted V-shaped recess and is deformed so that a force is applied to the side edges 42 and generates another type of resistance force. Applicant recognizes that the resistance force for the conventional blade 4 comes from the shape of the conventional blade 4 and needs to be improved.

The present invention intends to provide a blade for paper punches and the blade is a hollow tubular blade and includes a single tip which generates a significant force to penetrate the paper sheets.

### SUMMARY OF THE INVENTION

The present invention relates to a blade for paper punches and includes a hollow tubular body with a passage defined axially therethrough and an inclined edge is defined in a lower end of the body. The inclination angle θ between the inclined edge and a stack of paper sheet is in a range between 15 to 50 degrees. A spring is located in the passage of the body so as to bias a push rod which is movable in the passage to remove debris from the passage.

The primary object of the present invention is to provide a blade for paper punches wherein the blade includes an inclined edge with one tip which efficiently penetrates through the paper sheets with less force.

Another object of the present invention is to provide a blade for paper punches wherein the blade is a hollow tubular body and a push rod is installed in the passage so as to easily remove the debris from the passage.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the paper punch with the blades of the present invention;

FIG. 2 is an exploded view to show the blade, the push rod and the spring of the present invention;

FIG. 3 is a cross sectional view to show the blade, the push rod and the spring of the present invention;

FIG. 4 shows the steps that the blade of the present invention punches the paper sheets;

FIGS. 5 to 9 are the charts showing the relationship between the force required and the inclination angle θ of the inclined edge of the blade of the present invention when punching different number of paper sheets;

FIG. 10 discloses a conventional blade of a paper punch;

FIG. 11 shows the steps that the conventional blade punches the paper sheets;

FIG. 12 is the chart showing the relationship between the force required and the number of paper sheets to be punched by the conventional blade, and

FIG. 13 is the chart showing the relationship between the force required and the number of paper sheets to be punches between the blade of the present invention and the conventional blade.

### DETAILED DESCRIPTION OF THE PREFERRED EMBODIMENT

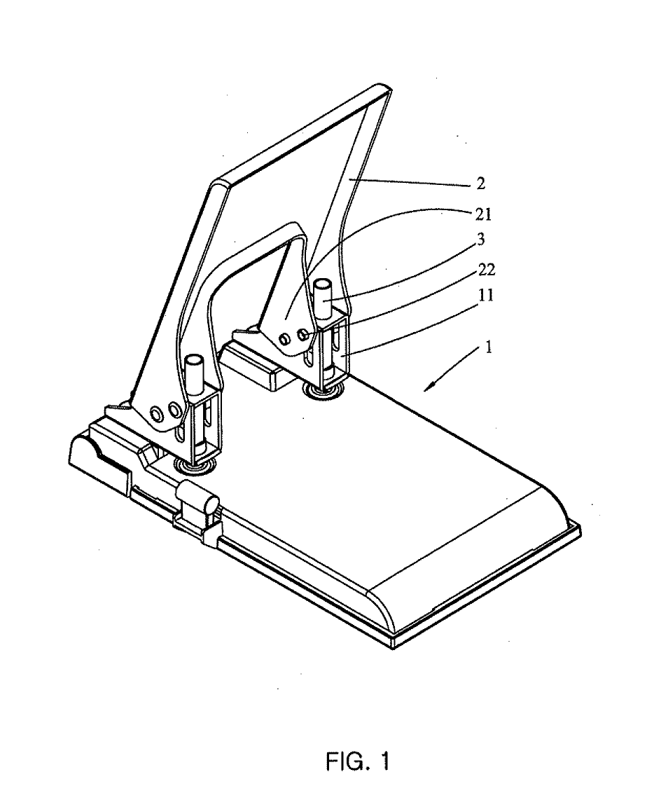

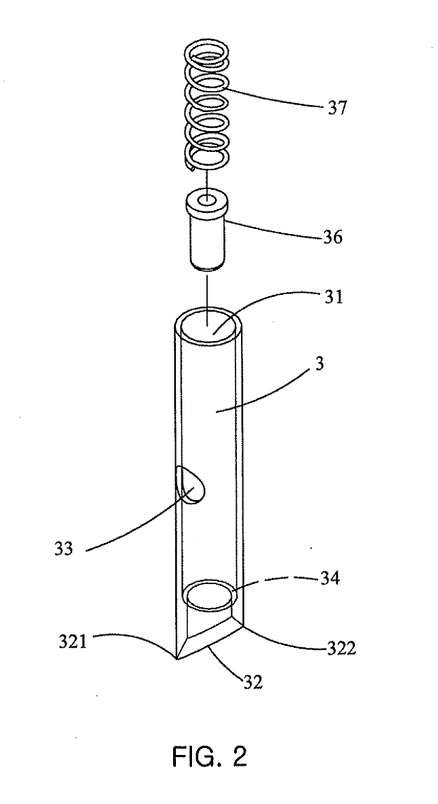

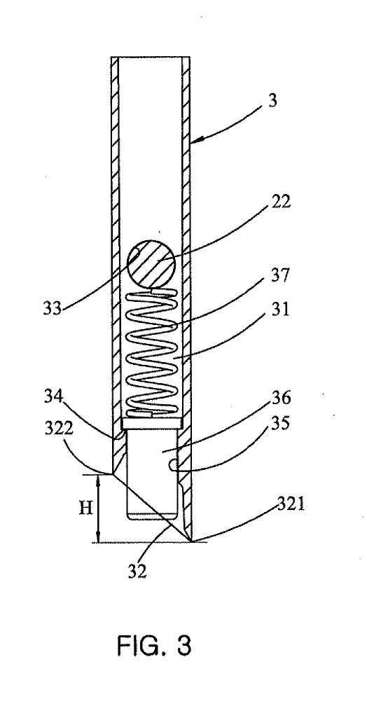

Referring to FIGS. 1 to 3, the paper punch 1 that is cooperated with the blade 3 for paper punches of the present invention comprises a base with two frames 11 connected on the top of the base and two blades 3 of the present invention are movably connected to the two frames 11. A U-shaped operation handle 2 includes a U-shaped arm 21 which is pivotably connected to the blades 3 and the frames 11.

The blade 3 of the present invention is a hollow tubular body with a passage 31 defined axially therethrough and an inclined edge 32 is defined in a lower end of the body. A hole 33 is defined through the wall of the body and a stepped shoulder 34 is defined in an inner periphery of the passage 31. The body of the blade 3 is inserted through the frame 11 corresponding thereto and a pin 22 extends through the hole 33 of the body and slots of the frame 11. Two ends of the pin 22 are connected with the handle 2 and the arm 21 respectively. An angle θ between the inclined edge 32 and a stack of paper sheets “A” is in a range between 15 to 50 degrees. The inclined edge 32 includes a lower tip 321 and an upper tip 322. A vertical distance between the lower tip 321 and the upper tip 322 is represented by “H”.

A spring 37 is located in the passage 31 of the body and biases a push rod 36 which is movable in the passage 31. The push rod 36 includes an enlarged flange at one end thereof which is stopped by the stepped shoulder 34. The spring 37 is biased between the pin 22 and the flange of the push rod 36.

The body includes a release hole 35 defined in the lower end of the body and located beneath the stepped shoulder 34. The push rod 36 is movable inserted into the release hole 35.

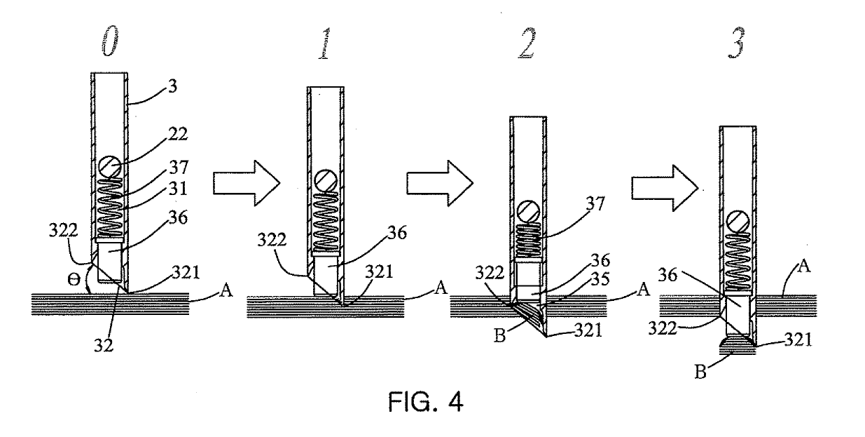

As shown in FIG. 4, when punching a stack of paper sheets “A”, the user pivots the operation handle 2 and the arm 21 downward, the inclined edge 32 is lowered and the lower tip 321 contacts the top sheet of the stack of paper sheets “A”. Because there is only one contact point, so that the lower tip 321 can efficiently penetrate the paper sheets “A” without too much resistance. After the lower tip 321 penetrates the paper sheets “A”, the inclined portion of the inclined edge 32 continues to cut the paper sheets “A” and the release hole 35 accommodates the debris “B”. The push rod 36 is pushed upward by the debris “B” and compresses the spring 37. When the upper tip 322 passes through the paper sheets “A”, there will be no force applied to the push rod 36 from the debris “B” so that the spring 37 pushes the push rod 36 downward to remove the debris “B” out from the release hole 35.

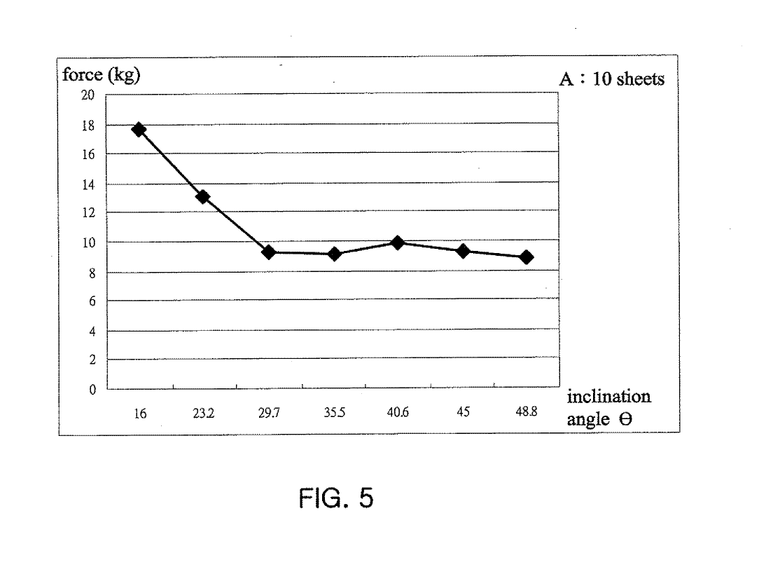

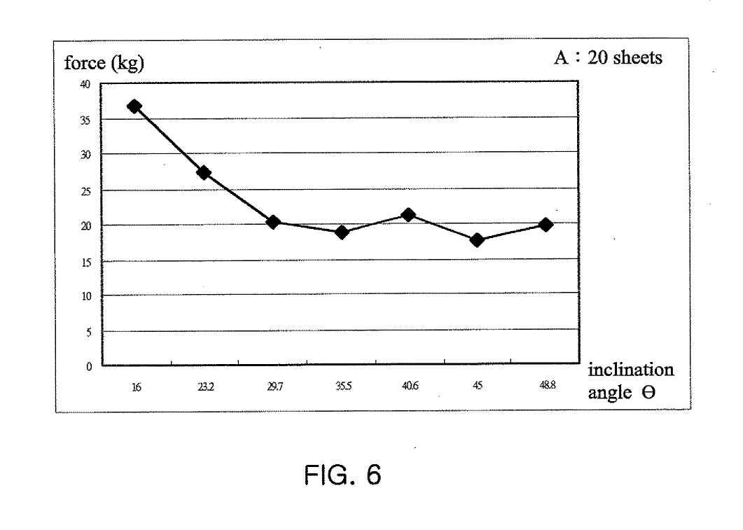

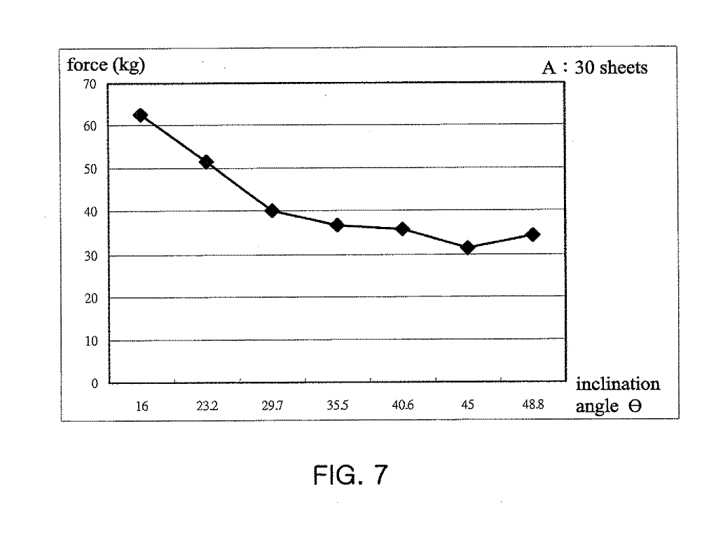

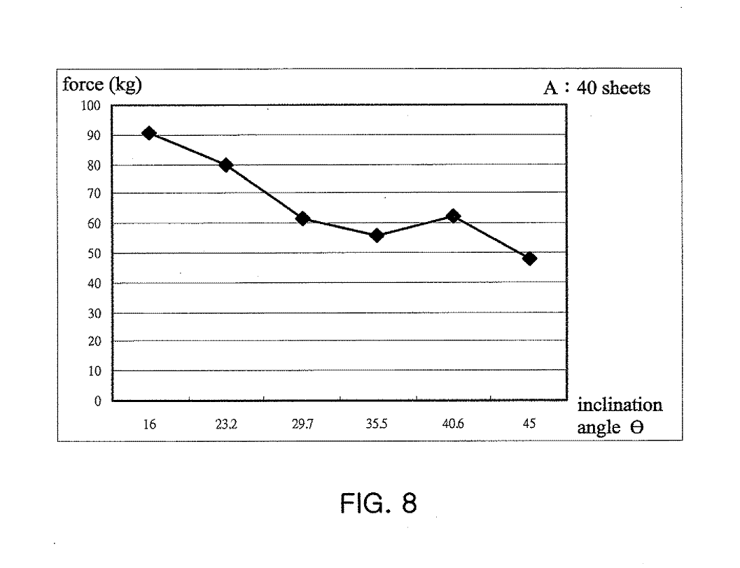

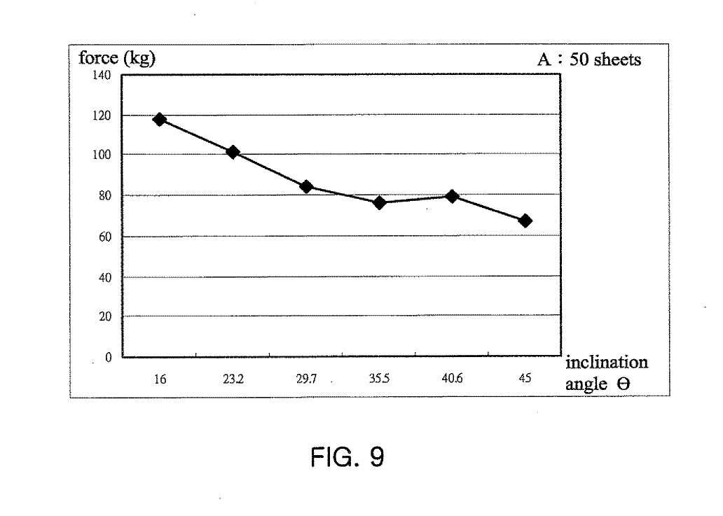

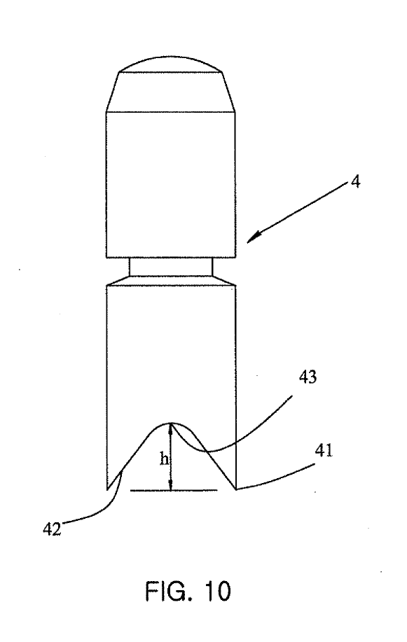

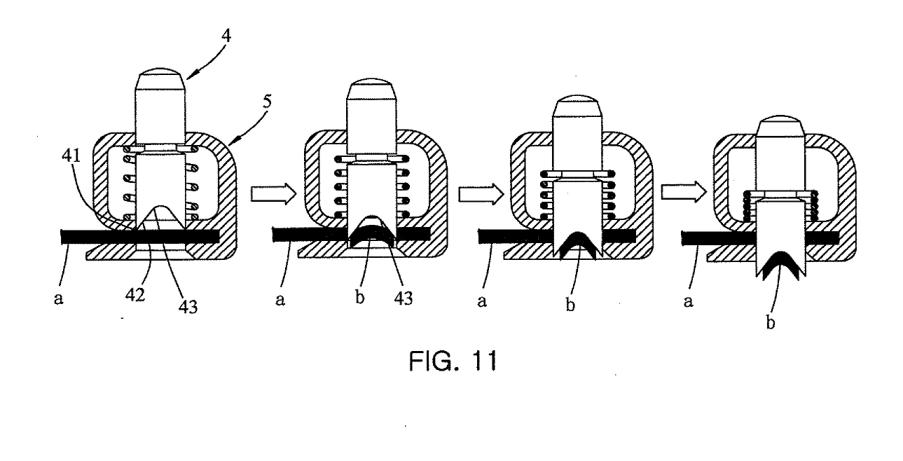

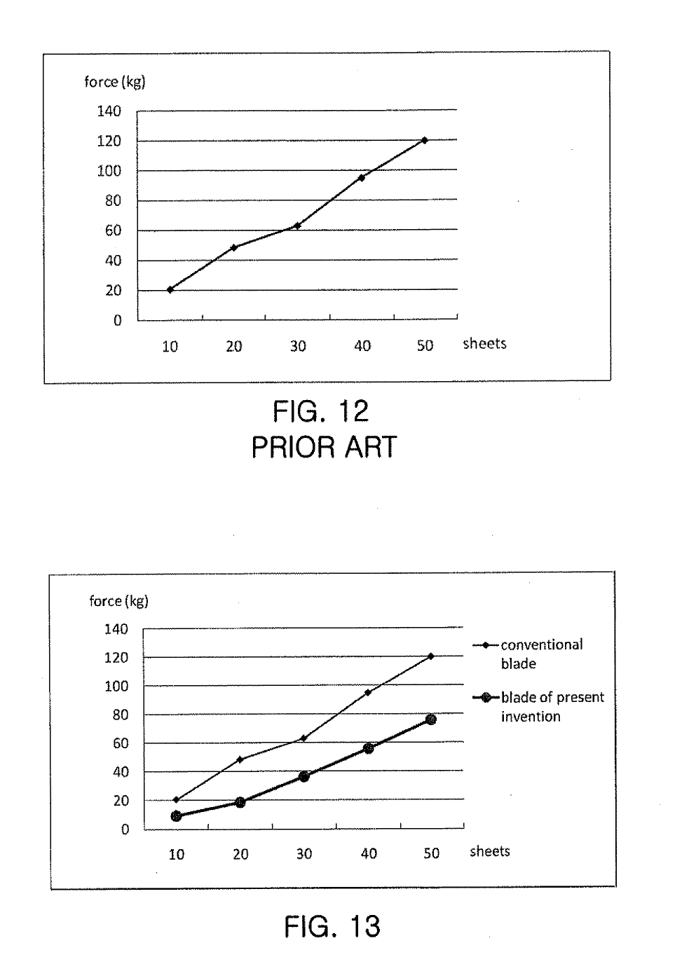

FIGS. 5 to 9 are the charts showing the relationship between the force required and the inclination angle θ of the inclined edge of the blade 3 of the present invention when punching different number of paper sheets “A”, wherein the X-axis represents the inclination angle θ (the distance “H”) and the Y-axis represents the force (kg) required to the blade 3. The X-axis discloses seven references which are 16° (2 mm), 23.2° (3 mm), 29.7° (4 mm), 35.5° (5 mm), 40.6° (6 mm), 45° (7 mm), and 48.8° (8 mm). The Y-axis discloses seven references which are from 0 kg, 10 kg, 20 kg, 30 kg, 40 kg and 50 kg. FIGS. 5 to 9 respectively disclose the relationship when punching 10 sheets, 20 sheets, 30 sheets, 40 sheets, and 50 sheets. Further referring to FIG. 13, which is chart showing the relationship between the force required and the number of paper sheets to be punches between the blade 3 of the present invention and the conventional blade.

According to the curves of the charts in FIGS. 5 to 9, and the chart of FIG. 13, the forces required for the conventional blade to punch the paper sheets of 10 sheets, 20 sheets, 30 sheets, 40 sheets, and 50 sheets are 20.6 kg, 48.4 kg, 63 kg, 95 kg and 120 kg.

The force required for the blade 3 of the present invention with the inclined angle θ of 29.7° to punch the paper sheets of 10 sheets is 9.24 kg. The force required for the blade 3 of the present invention with the inclined angle θ of 35.5° to punch the paper sheets of 20 sheets is 18.68 kg. The force required for the blade 3 of the present invention with the inclined angle θ of 35.5° to punch the paper sheets of 30 sheets is 36.52 kg. The force required for the blade 3 of the present invention with the inclined angle θ of 35.5° to punch the paper sheets of 40 sheets is 56 kg. The force required for the blade 3 of the present invention with the inclined angle θ of 35.5° to punch the paper sheets of 50 sheets is 76 kg. The blade 3 of the present invention obviously is more efficient than the conventional blade.

The blade 3 of the present invention includes an inclined edge 32 so that only one lower tip 321 contacts the paper sheets “A” and the single contact point reduces the resistance from the paper sheets “A”. The push rod 36 is designed to push the debris “B” from the release hole 35 in the final stage of punch to avoid the blade 3 from being stocked by the debris “B”.

While we have shown and described the embodiment in accordance with the present invention, it should be clear to those skilled in the art that further embodiments may be made without departing from the scope of the present invention.

What is claimed is:

1. A blade for paper punches comprising:
a hollow tubular body with a passage defined axially therethrough and an inclined edge defined in a lower end of the body.

2. The blade as claimed in claim 1, wherein an angle between the inclined edge and a stack of paper sheet is in a range between 15 to 50 degrees.

3. The blade as claimed in claim 1, wherein a spring is located in the passage of the body and biases a push rod which is movable in the passage.

4. The blade as claimed in claim 3, wherein a stepped shoulder is defined in an inner periphery of the passage and the push rod has one end stopped by the stepped shoulder.

5. The blade as claimed in claim 4, wherein the body includes a release hole defined in the lower end of the body and located beneath the stepped shoulder.
